(19) United States
(12) Patent Application Publication
(10) Pub. No.: US 2007/0038761 A1
(43) Pub. Date: Feb. 15, 2007

(54) Method and apparatus for detecting the location of a user and for facilitating access to location-specific applications

(76) Inventor: Haim Tebeka, Palo Alto, CA (US)

Correspondence Address: STATTLER JOHANSEN & ADELI LLP, 540 UNIVERSITY AVENUE, SUITE 350, PALO ALTO, CA, 94301, US

(21) Appl. No.: 11/203,067

(22) Filed: Aug. 11, 2005

(51) Int. Cl. G06F 15/16

(52) U.S. Cl. 709/228

(57) ABSTRACT

A method and apparatus for detecting the location of a user and for facilitating access to location-specific applications are described. In one embodiment, one or more connections available to the user are detected based on at least one predetermined priority parameter. One or more potential locations of the user are further displayed based on the detected connections, the potential locations further including a proposed location selected for the user. A selected location is further received from the user and associated location-specific settings and applications are further retrieved based on the selected location and a time parameter. In one embodiment, location parameters of the selected location are stored within a data structure for further processing.

### TECHNICAL FIELD

The invention relates generally to the field of network-based communications and, more particularly, to a method and apparatus for detecting the location of a user and for facilitating access to location-specific applications for the user.

### BACKGROUND

In recent years, the exponential increase in communications among users, especially in the wireless domain, and the subsequent increase in the number of computing and communication devices available to users have created a growing demand for portability of such computing and communication devices and for efficient integration of the devices within each particular environment where the user may be located at any given time.

The popularity of personal digital assistant devices (PDAs), which are handheld or mobile computing devices that combine computing capabilities, telephone/fax capabilities, and various Internet and other networking features, and which can function as a cellular phone, a Web browser, and/or a personal organizer, has translated into an increased number of applications created for such devices and into complex device settings for their ever growing number of features. Thus, it would be advantageous to provide customized solutions for display of such applications and for activating of custom settings for such devices based on the location of the user at a particular time.

### SUMMARY

A method and apparatus for detecting the location of a user and for facilitating access to location-specific applications are described. In one embodiment, one or more connections available to the user are detected based on at least one predetermined priority parameter. One or more potential locations of the user are further displayed based on the detected connections, the potential locations further including a proposed location selected for the user. A selected location is further received from the user and associated location-specific settings and applications are further retrieved based on the selected location and a time parameter. In one embodiment, location parameters of the selected location are stored within a data structure for further processing.

### BRIEF DESCRIPTION OF THE DRAWINGS

FIG. 1 is a block diagram illustrating an exemplary apparatus for detecting the location of a user and for facilitating access to location-specific applications, according to one embodiment of the invention;

FIG. 2 is a block diagram illustrating an exemplary database, which at least partially implements and supports the apparatus for detecting the location of a user and for facilitating access to location-specific applications, according to one embodiment of the invention;

FIG. 3 is a flow diagram illustrating a method for detecting the location of a user and for facilitating access to location-specific applications, according to one embodiment of the invention;

FIG. 4 is a flow diagram illustrating a method for storing parameters of a selected location, according to one embodiment of the invention; and

FIG. 5 is a diagrammatic representation of a machine in the exemplary form of a computer system within which a set of instructions may be executed.

### DETAILED DESCRIPTION

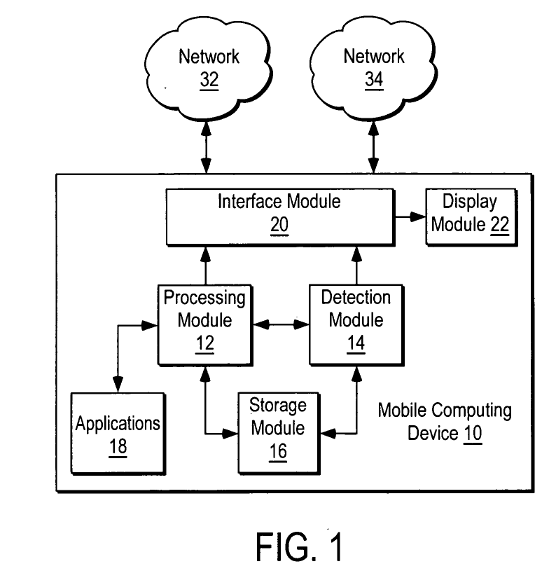

FIG. 1 is a block diagram illustrating an exemplary apparatus, such as, for example, a mobile computing device 10, for detecting the location of an entity or user and for facilitating access to location-specific applications, according to one embodiment of the invention. While an exemplary embodiment of the invention is described within the context of a mobile computing device 10, such as, for example, a Personal Digital Assistant (PDA), or any other handheld or mobile device capable of performing various computing, telephone, Internet, and/or networking operations, it will be appreciated by those skilled in the art that the invention will find application in many different types of computer-based, and network-based, devices.

The device 10 includes one or more of a number of types of hardware and/or software modules configured to perform one or more of the operations described in further detail below. In one embodiment, the device 10 includes a processing module 12 coupled to a detection module 14. The processing module 12 and the detection module 14 maintain and facilitate access to a storage module 16. The processing module 12 also accesses applications 18 and facilitates selective access to such applications. The storage module 16 includes a data structure for storing records for the entity or user of the device 10, location information related to the user, connection types available at each stored location, as described in further detail below.

In one embodiment, upon receiving of an initiation command, such as, for example, a power up command or a predetermined detection command initiated by the user, the detection module 14 within the mobile computing device 10 detects any available connection types at the current location of the device 10, and retrieves associated potential locations, as described in further detail below. Subsequent to display of the retrieved potential locations and selection of the specific location where the mobile computing device 10 resides, the processing module 12 stores location parameters of the selected location in the database 16, retrieves associated settings and/or applications based on the selected location and the current time parameter, and facilitates access to the applications for the user, as described in further detail below. In an alternate embodiment, the detection module 14 scans the available connections periodically, as specified by the user with a user configurable refresh rate, and provides updates or confirms the selected location of the mobile computing device 10 within a predetermined time interval.

The device 10 further includes an interface module 20 coupled to a display module 22. The interface module 20 receives data from the processing module 12 and the detection module 14 and displays data for the user on the display module 22. The interface module 20 may be accessed by a client program, such as a browser, e.g. the Internet Explorer browser distributed by Microsoft Corporation of Redmond, Wash., that may interact with one or more networks 32, 34, such as, for example, the Internet. Other examples of networks 32, 34 include a wide area network (WAN), a local area network (LAN), a wireless network, e.g. a cellular network, a Bluetooth-enabled network, the Plain Old Telephone Service (POTS) network, or any other known networks.

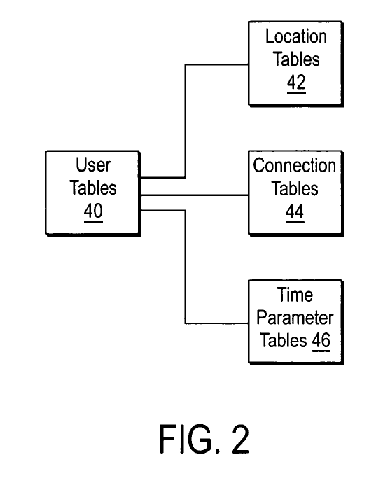

FIG. 2 is a block diagram illustrating an exemplary implementation of the data structure within the storage module 16, in the form of a database 36 maintained and accessed by the processing module 12 and the detection module 14, which at least partially implements and supports the device 10, according to one embodiment of the invention. The database 36 may, in one embodiment, be implemented as a relational database, and includes a number of tables having entries, or records, which are linked by indices and keys. In an alternative embodiment, the database 36 may be implemented as a collection of objects in an object-oriented database.

Central to the database 36 shown in FIG. 2 are user tables 40, which contain records for the entity or user of the device 10. The database 36 also includes location tables 42, which may be linked to the user tables 40 and may be populated with location information related to the user of the device 10, such as, for example, various locations frequented by the user, e.g. his/her home, workplace, one or more client sites, stores, and any other such locations.

The database 36 may include a number of other tables, which may also be shown to be linked to the user tables 40, for example, tables specifically provided to enable an exemplary embodiment of the invention. One or more time parameter tables 46 are configured to store various time parameters linked to the habits of the user, which indicate when is the user most likely to be at each specific location stored in the location tables 42. One or more connection tables 44 are configured to store connection types available at each location stored in the location tables 42, such as, for example, Bluetooth wireless connections, Wireless Fidelity (Wi-Fi) network connections, cellular tower connections, hardwired connections, infrared connections, Global Positioning System (GPS) connections, cradle connections, serial connections, firewire connections, Universal Serial Bus (USB) connections, and other known connection types.

In one embodiment, the connection types stored in the connection tables 44 and the time parameters stored in the time tables 46 contain assigned predetermined priority parameters used in the detection process. For example, wired or fixed connections have a higher priority than wireless connections because they are more likely to pinpoint an accurate location for the device 10, while each stored time parameter has a lower priority than either of the above mentioned connection types due to potential randomness in a user's habits at any given time. In addition, within the same group of wired and, respectively, wireless connections, some connections are assigned higher priority parameters relative to the others, such that, for example, Wi-Fi connections have higher priority than Bluetooth connections within the wireless connections group. In one embodiment, the user may override the assigned priority parameters and assign new priority parameters to the connection types.

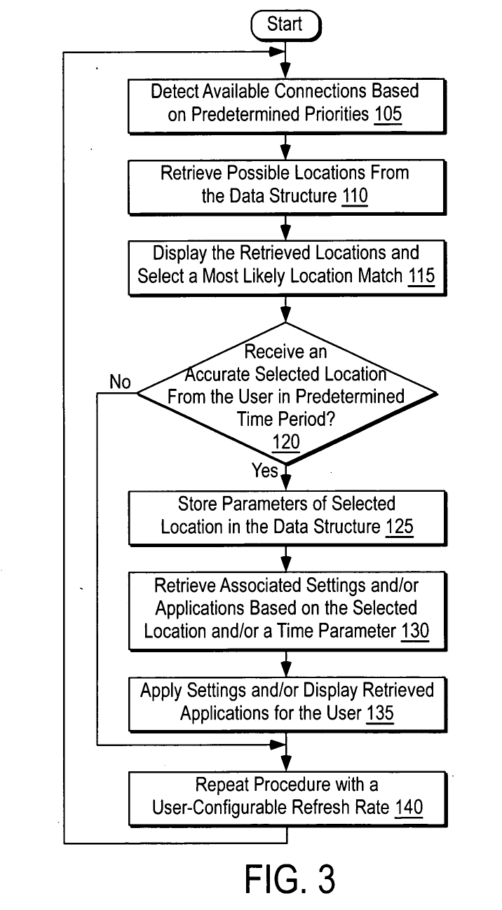

FIG. 3 is a flow diagram illustrating a method for detecting the location of a user and for facilitating access to location-specific applications, according to one embodiment of the invention. As illustrated in FIG. 3, in one embodiment, the procedure commences at processing block 105 with the detection of available connections based on respective predetermined priorities. In one embodiment, upon receipt of an initiation command, or as a result of a periodic scan with a user configurable refresh rate, the detection module 14 detects any available wired connections based on the assigned priority parameters. Subsequently, the detection module 14 detects any available wireless connections based on their corresponding assigned priority parameters.

At processing block 110, one or more potential locations of the mobile computing device 10 are retrieved from the data structure within the storage module 16, such as, for example, the database 36. In one embodiment, the detection module 14 accesses the location tables 42 and the connections tables 44 within the database 36 and retrieves one or more possible locations where the user and the mobile computing device 10 may currently reside based on the detected connection types. In an alternate embodiment, the detection module 14 may access the time parameter tables 46 to better define the retrieved potential locations based on the stored time parameters linked to the user's habits. For example, the detection module 14 may access the time parameter tables 46 to determine whether the user's habits at the current time parameter may pinpoint the potential locations with greater accuracy.

At processing block 115, the retrieved potential locations are displayed and a most likely location is selected for the user. In one embodiment, based on the data retrieved from the location tables 42, the connections tables 44, and the time parameter tables 46, the detection module 14 selects a proposed location where the mobile computing device 10 may be currently located and communicates with the interface module 20 to display the list of potential locations for the user. The interface module 20 receives the data from the detection module 14 and displays the potential locations for the user on the display module 22. In one embodiment, the proposed location selected as the most likely location is highlighted among the displayed potential locations.

In an alternate embodiment, if the detection module 14 retrieves only one potential location, or if it determines that there is no ambiguity among the retrieved potential locations and that a proposed location is accurate, the location will automatically trigger events or applications related to that location and the procedure will jump to processing block 125.

At processing block 120, a decision is made whether an accurate selected location is received from the user in a predetermined time period. If no selection is received from the user, the procedure jumps to processing block 140.

Otherwise, in one embodiment, the interface module 20 receives a selected location from the user within the predetermined time period and transmits the selected location to the processing module 12. The user may confirm the proposed location selected as the most likely location with a conventional command or may select a different location from the list of potential locations displayed on the display module 22.

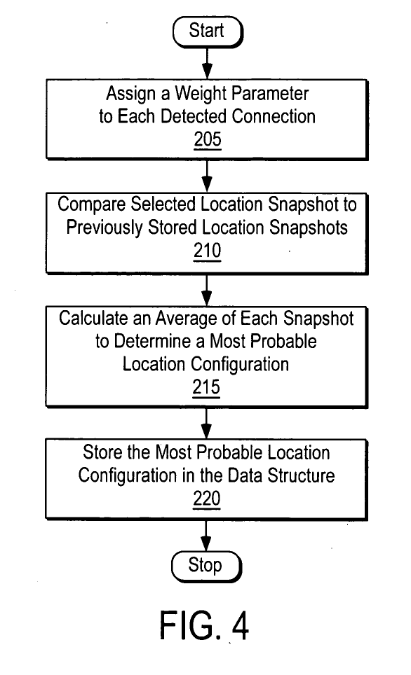

At processing block 125, location parameters of the selected location are stored in the data structure within the storage module 16, such as, for example, the database 36. In one embodiment, the processing module 12 stores the location parameters of the selected location in appropriate tables within the database 36, as described in further detail below in connection with FIG. 4.

At processing block 130, settings and/or applications associated with the selected location are retrieved based on the selected location information and the current time parameter. In one embodiment, the processing module 12 accesses the database 36 and/or the applications 18 to retrieve settings for the device 10 associated with the selected location and the current time parameter, such as, for example, a ring level setting, an alarm level setting, a display brightness setting, a predetermined display sequence for the retrieved applications 18, locking and/or unlocking capabilities for the device 10, and other settings associated with the selected location.

In an alternate embodiment, the processing module 12 may retrieve location-specific applications for the current time parameter, such as, for example, task lists for the particular location selected, and/or location-specific calendar and appointment applications, for further display of such location-specific applications for the user on the display module 22.

At processing block 135, the retrieved settings are applied to the device 10 and/or the retrieved location-specific applications are further displayed for the user. In one embodiment, the processing module 12 implements the retrieved settings on the device 10. Alternatively, the processing module 12 communicates with the interface module 20 to display the retrieved location-specific applications on the display module 22. For example, the processing module 12 may activate the location-specific calendar and appointment capabilities and set reminders for appointments based on the current selected location versus the location of the appointment. In another example, the processing module 12 may display a location-specific task list for the current selected location at the current time, such as a to-do list for the home location only, or a task list for the office location only, or a shopping list for a particular store where the user may be headed.

Finally, at processing block 140, the procedure is repeated with a user-configurable refresh rate and, thus, the procedure jumps to processing block 105. In one embodiment, the refresh rate may vary according to the time of the day and based on the habits of the user.

FIG. 4 is a flow diagram illustrating a method for storing parameters of a selected location, according to one embodiment of the invention. As illustrated in FIG. 4, at processing block 205, subsequent to receipt of a selected location from the user, a weight parameter is assigned to each detected connection type of the selected location. In one embodiment, the processing module 12 receives the selected location from the user and further receives all available connections detected by the detection module 14. Subsequently, the processing module 12 assigns a weight parameter to each detected connection type of the selected location for the specified current time parameter, creating a selected location snapshot at that particular time.

At processing block 210, the selected location snapshot is compared to previous location snapshots stored in the database 36. In one embodiment, the processing module 12 accesses respective tables within the database 36 to retrieve previously stored location snapshots, such as, for example, previously stored weight parameters of connection types stored in the connection tables 44 linked to the same location stored in the location tables 42.

At processing block 215, an average of the snapshots is calculated to determine a most probable location configuration for the selected location. In one embodiment, the processing module 12 calculates an average of the assigned weight parameters of the detected connection types for the current time parameter and of the previously stored weight parameters of the detected connection types for previous time parameters to determine a most probable location configuration for the selected location, including most commonly applied settings for the device 10 and location-specific applications displayed for the user.

Finally, at processing block 220, the most probable location configuration is stored in the data structure within the storage module 16, such as, for example, the database 36. In one embodiment, the processing module 12 stores the most probable location configuration for the selected location in respective tables of the database 36. The stored location configuration may subsequently be updated if the particular location is again selected by the user as the location of the device 10 and the detected connection types have changed for the new time parameter.

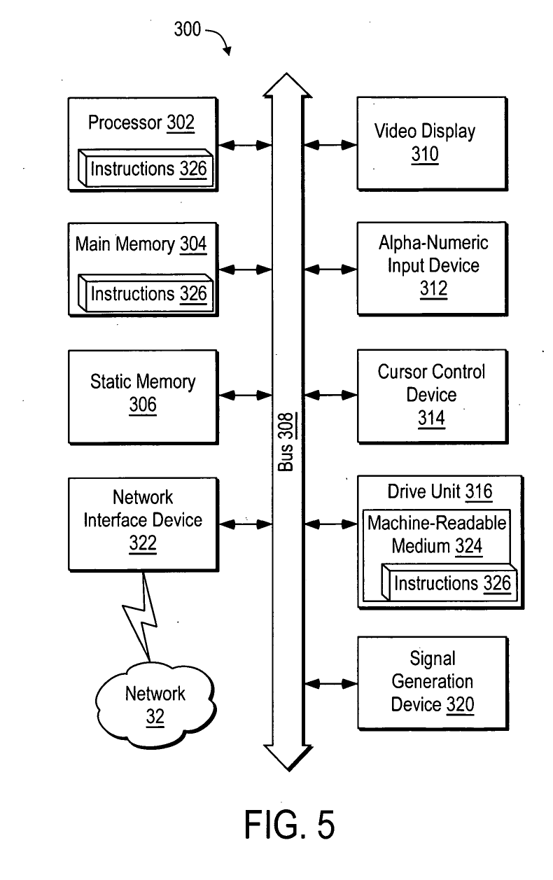

FIG. 5 shows a diagrammatic representation of a machine in the exemplary form of a computer system 300 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a GPS device, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310, e.g. a liquid crystal display (LCD) or a cathode ray tube (CRT). The computer system 300 also includes an alphanumeric input device 312, e.g, a keyboard, a cursor control device 314, e.g. a mouse, a disk drive unit 316, a signal generation device 318, e.g. a speaker, and a network interface device 320.

The disk drive unit 316 includes a machine-readable medium 324 on which is stored a set of instructions, i.e. software, 326 embodying any one, or all, of the methodologies described above. The software 326 is also shown to reside, completely or at least partially, within the main memory 304 and/or within the processor 302. The software 326 may further be transmitted or received via the network interface device 320.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method for detecting a location of a user, the method comprising:
determining at least one potential location of said user based on at least one connection available to said user at said at least one potential location;
receiving a selected location from said user; and
retrieving associated location-specific applications based on said selected location and a time parameter for further access by said user.

2. The method according to claim 1, wherein said determining further comprises:
detecting said at least one connection available to said user based on at least one predetermined priority parameter; and
displaying said at least one potential location based on said at least one connection, said at least one potential location further comprising a proposed location selected for said user.

3. The method according to claim 1, further comprising storing at least one parameter of said selected location in a data structure.

4. The method according to claim 1, further comprising displaying a location-specific calendar and appointment application for the user.

5. The method according to claim 1, further comprising displaying a location-specific task list for said user at said time parameter.

6. The method according to claim 1, further comprising displaying a location-specific shopping list for said user at said time parameter.

7. The method according to claim 1, wherein said at least one connection further comprises any of Bluetooth wireless connections, Wireless Fidelity (Wi-Fi) network connections, cellular tower connections, hardwired connections, infrared connections, Global Positioning System (GPS) connections, cradle connections, serial connections, firewire connections, Universal Serial Bus (USB) connections.

8. An apparatus for detecting a location of a user, the apparatus comprising:
a detection module for determining at least one potential location of said user based on at least one connection available to said user at said at least one potential location;
an interface module, coupled to said detection module, for receiving a selected location from said user; and
a processing module, coupled to said detection module and said interface module for retrieving associated location-specific applications based on said selected location and a time parameter for further access by said user.

9. The apparatus according to claim 8, wherein said detection module further detects said at least one connection available to said user based on at least one predetermined priority parameter and wherein said interface module further displays said at least one potential location based on said at least one connection, said at least one potential location further comprising a proposed location selected for said user.

10. The apparatus according to claim 8, wherein said processing module further stores at least one parameter of said selected location in a data structure.

11. The apparatus according to claim 8, wherein said interface module further displays a location-specific calendar and appointment application for the user.

12. The apparatus according to claim 8, wherein said interface module further displays a location-specific task list for said user at said time parameter.

13. The apparatus according to claim 8, wherein said interface module further displays a location-specific shopping list for said user at said time parameter.

14. The apparatus according to claim 8, wherein said at least one connection further comprises any of Bluetooth wireless connections, Wireless Fidelity (Wi-Fi) network connections, cellular tower connections, hardwired connections, infrared connections, Global Positioning System (GPS) connections, cradle connections, serial connections, firewire connections, Universal Serial Bus (USB) connections.

15. A computer readable medium containing executable instructions, which, when executed in a processing system, cause said processing system to perform a method for detecting a location of a user, the method comprising:
determining at least one potential location of said user based on at least one connection available to said user at said at least one potential location;
receiving a selected location from said user; and
retrieving associated location-specific applications based on said selected location and a time parameter for further access by said user.

16. The computer readable medium according to claim 15, wherein said determining further comprises:
detecting said at least one connection available to said user based on at least one predetermined priority parameter; and
displaying said at least one potential location based on said at least one connection, said at least one potential location further comprising a proposed location selected for said user.

17. The computer readable medium according to claim 15, wherein said method further comprises storing at least one parameter of said selected location in a data structure.

18. An apparatus for detecting a location of a user, the apparatus comprising:
means for determining at least one potential location of said user based on at least one connection available to said user at said at least one potential location;
means for receiving a selected location from said user; and
means for retrieving associated location-specific applications based on said selected location and a time parameter for further access by said user.

19. The apparatus according to claim 18, further comprising:
means for detecting said at least one connection available to said user based on at least one predetermined priority parameter; and
means for displaying said at least one potential location based on said at least one connection, said at least one potential location further comprising a proposed location selected for said user.

20. The apparatus according to claim 18, further comprising means for storing at least one parameter of said selected location in a data structure.
